(19) United States
(12) Patent Application Publication
(10) Pub. No.: US 2023/0351122 A1
(43) Pub. Date: Nov. 2, 2023

(54) RECOMMENDATION INFORMATION PRESENTATION DEVICE, OPERATION METHOD OF RECOMMENDATION INFORMATION PRESENTATION DEVICE, OPERATION PROGRAM OF RECOMMENDATION INFORMATION PRESENTATION DEVICE

(71) Applicant: FUJIFILM Corporation, Tokyo (JP)

(72) Inventor: Yasuhiko KANEKO, Saitama-shi (JP)

(73) Assignee: FUJIFILM Corporation, Tokyo (JP)

(21) Appl. No.: 18/351,790

(22) Filed: Jul. 13, 2023

Related U.S. Application Data
(63) Continuation of application No. PCT/JP2021/047187, filed on Dec. 21, 2021.

(30) Foreign Application Priority Data
Feb. 19, 2021 (JP) 2021-025550

(51) Int. Cl. G06F 40/56; G06F 40/242

(52) U.S. Cl. CPC G06F 40/56; G06F 40/242

(57) ABSTRACT

Provided are a recommendation information presentation device, an operation method of a recommendation information presentation device, and an operation program of a recommendation information presentation device capable of presenting recommendation information filled with unexpectedness to a user. A CPU of an image management server includes a second analysis unit, a creation unit, an information acquisition unit, and a distribution control unit. The second analysis unit analyzes an image to generate analysis information. The creation unit inputs the analysis information into a model for story creation and causes a story configured of a set of sentences describing a fictitious event based on the analysis information to be output from the model for story creation. The information acquisition unit selects recommendation information according to the story. The distribution control unit presents the recommendation information to the user.

### CROSS-REFERENCE TO RELATED APPLICATIONS

This application is a continuation application of International Application No. PCT/JP2021/047187 filed on Dec. 21, 2021, the disclosure of which is incorporated herein by reference in its entirety. Further, this application claims priority from Japanese Patent Application No. 2021-025550 filed on Feb. 19, 2021, the disclosure of which is incorporated herein by reference in its entirety.

### BACKGROUND

### 1. Technical Field

The technique of the present disclosure relates to a recommendation information presentation device, an operation method of a recommendation information presentation device, and an operation program of a recommendation information presentation device.

### 2. Description of the Related Art

Presentation of recommendation information that is appropriate for a user has been performed. For example, JP2019-164421A describes a technique of calculating, based on an image held by the user such as an image of wearing favorite clothing, an evaluation value representing a personality preference of the user and presenting information on a product corresponding to the calculated evaluation value as the recommendation information.

### SUMMARY

In the technique described in JP2019-164421A, there is little unexpectedness since only the information on the product corresponding to a subject of the image held by the user is simply presented.

One embodiment according to the technique of the present disclosure provides a recommendation information presentation device, an operation method of the recommendation information presentation device, and an operation program of the recommendation information presentation device capable of presenting recommendation information filled with unexpectedness to a user.

A recommendation information presentation device of the present disclosure comprises a processor, and a memory connected to or built into the processor. The processor analyzes an image held by a user to generate analysis information, inputs the analysis information to a machine learning model for story creation and causes a story configured of a set of sentences describing a fictitious event based on the analysis information to be output from the machine learning model for story creation, generates recommendation information according to the story, and presents the recommendation information to the user.

It is preferable that the processor generates, as the analysis information, at least one of content analysis information obtained by analyzing a content of the image, personality-preference analysis information obtained by analyzing a personality preference of the user, or processed personality-preference analysis information that is information obtained by processing the personality-preference analysis information and represents a personality preference different from the personality preference of the user.

It is preferable that the processor generates the content analysis information from the image by using a machine learning model for content analysis.

It is preferable that the processor generates the personality-preference analysis information from the content analysis information by using a personality-preference conversion dictionary.

It is preferable that the processor selects the recommendation information according to the story from a plurality of pieces of the recommendation information registered in advance.

It is preferable that the processor inputs an auxiliary motif that assists in creating the story to the machine learning model for story creation, in addition to the analysis information.

An operation method of a recommendation information presentation device of the present disclosure comprises analyzing an image held by a user to generate analysis information, inputting the analysis information to a machine learning model for story creation and causing a story configured of a set of sentences describing a fictitious event based on the analysis information to be output from the machine learning model for story creation, generating recommendation information according to the story, and presenting the recommendation information to the user.

An operation program of a recommendation information presentation device of the present disclosure causes a computer to execute a process comprising analyzing an image held by a user to generate analysis information, inputting the analysis information to a machine learning model for story creation and causing a story configured of a set of sentences describing a fictitious event based on the analysis information to be output from the machine learning model for story creation, generating recommendation information according to the story, and presenting the recommendation information to the user.

According to the technique of the present disclosure, it is possible to provide the recommendation information presentation device, the operation method of the recommendation information presentation device, and the operation program of the recommendation information presentation device capable of presenting the recommendation information filled with unexpectedness to the user.

### BRIEF DESCRIPTION OF THE DRAWINGS

Exemplary embodiments according to the technique of the present disclosure will be described in detail based on the following figures, wherein:

FIG. 1 is a diagram showing an image management system;

FIG. 2 is a diagram showing information exchanged between an image management server and a user terminal;

FIG. 3 is a diagram showing the inside of an image DB;

FIG. 4 is a diagram showing the inside of a recommendation information DB and a content of recommendation information;

FIG. 5 is a block diagram showing a computer constituting the image management server and the user terminal;

FIG. 6 is a block diagram showing a processing unit of a CPU of the image management server;

FIG. 7 is a diagram showing a content of a story creation request;

FIG. 8 is a diagram showing processing of a first analysis unit;

FIG. 9 is a diagram showing processing of a second analysis unit;

FIG. 10 is a diagram showing formation of a model for story creation;

FIG. 11 is a diagram showing processing of a creation unit;

FIG. 12 is a diagram showing an example of a story and recommendation information according to the story;

FIG. 13 is a block diagram showing a processing unit of a CPU of the user terminal;

FIG. 14 is a diagram showing an image list display screen;

FIG. 15 is a diagram showing the image list display screen on which a context menu is displayed;

FIG. 16 is a diagram showing a story creation instruction screen;

FIG. 17 is a diagram showing a story display screen;

FIG. 18 is a flowchart showing a processing procedure of the image management server;

FIG. 19 is a diagram showing an aspect in which a plurality of pieces of personality-preference analysis information based on a plurality of images are input to the model for story creation;

FIG. 20 is a diagram showing an aspect in which content analysis information is input to the model for story creation;

FIG. 21 is a diagram showing an aspect in which the content analysis information and the personality-preference analysis information are input to the model for story creation;

FIG. 22 is a diagram showing an aspect in which processed personality-preference analysis information is input to a model for story creation; and

FIG. 23 is a diagram showing an aspect in which an auxiliary motif is input to the model for story creation.

### DETAILED DESCRIPTION

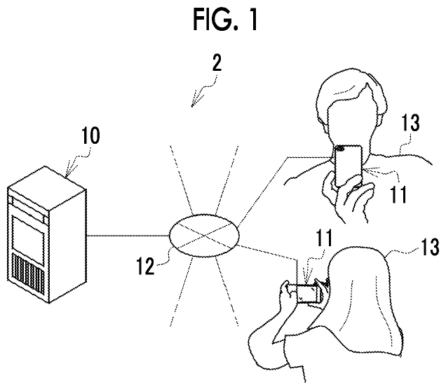

As shown in FIG. 1 as an example, an image management system 2 comprises an image management server 10 and a plurality of user terminals 11. The image management server 10 and the user terminal 11 are communicably connected via a network 12. The network 12 is, for example, a wide area network (WAN) such as the Internet and a public communication network.

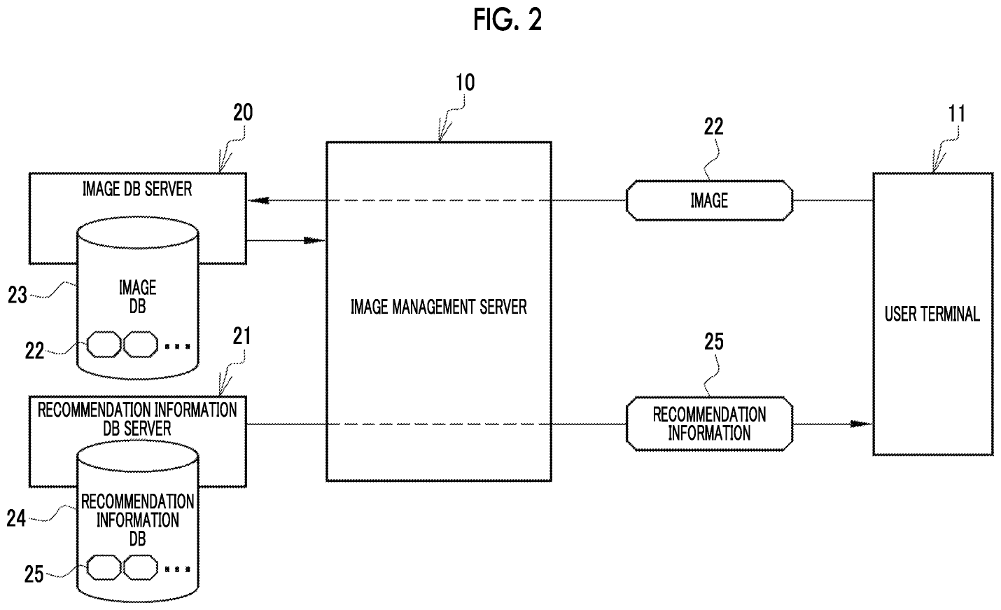

The image management server 10 is, for example, a server computer or a workstation, and is an example of a “recommendation information presentation device” according to the technique of the present disclosure. The user terminal 11 is a terminal owned by each user 13. The user terminal 11 has at least a function of reproducing and displaying an image 22 (refer to FIG. 2 and the like) and a function of transmitting the image 22 to the image management server 10. The user terminal 11 is, for example, a smartphone, a tablet terminal, a personal computer, and the like.

As shown in FIG. 2 as an example, an image database (hereinafter abbreviated as DB) server 20 and a recommendation information DB server 21 are connected to the image management server 10 via a network (not shown) such as a local area network (LAN). The image management server 10 transmits the image 22 from the user terminal 11 to the image DB server 20. The image DB server 20 has an image DB 23. The image DB server 20 accumulates and manages the image 22 from the image management server 10 in the image DB 23. Further, the image DB server 20 transmits the image 22 accumulated in the image DB 23 to the image management server 10 in response to a request from the image management server 10.

The recommendation information DB server 21 has a recommendation information DB 24. Recommendation information 25 is stored in the recommendation information DB 24. The recommendation information 25 is information on a product and a store recommended to the user 13. The recommendation information 25 is registered in advance by an employee of a product seller or an employee of the store. The recommendation information DB server 21 transmits the recommendation information 25 of the recommendation information DB 24 to the image management server 10 in response to a request from the image management server 10. The image management server 10 distributes the recommendation information 25 to the user terminal 11.

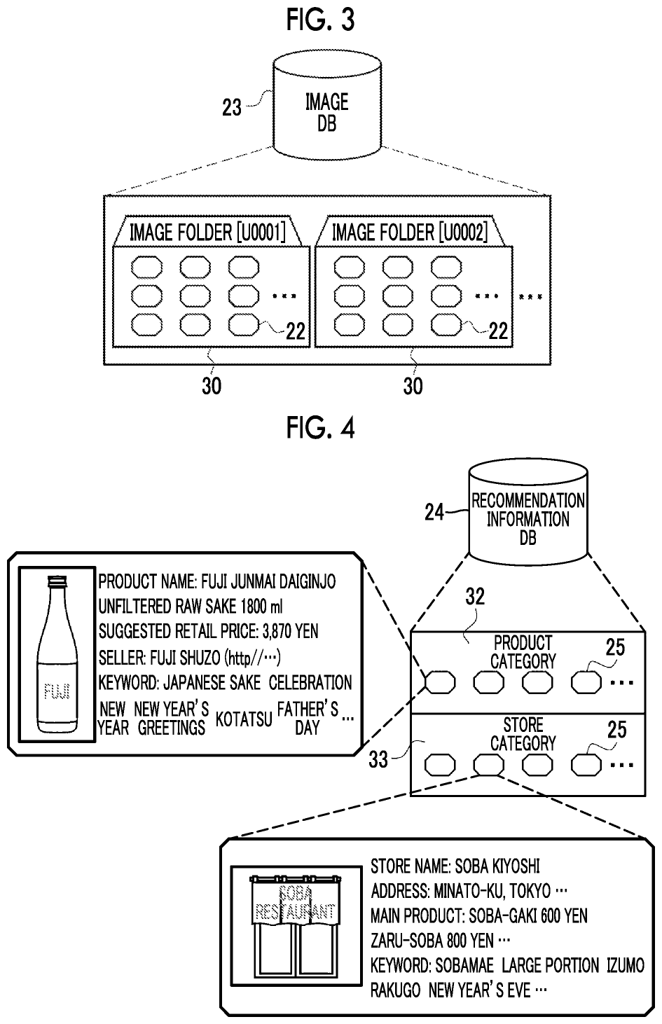

As shown in FIG. 3 as an example, a plurality of image folders 30 are provided in the image DB 23. The image folder 30 is a folder addressed to each user 13 one by one and is a folder unique to one user 13. Therefore, the image folders 30 are provided for the number of users 13. A user identification data (ID) for uniquely identifying the user 13, such as [U0001] or [U0002], is associated with the image folder 30.

The image 22 owned by the user 13 is stored in the image folder 30. The image 22 owned by the user 13 includes an image captured by the user 13 using a camera function of the user terminal 11. Further, the image 22 owned by the user 13 includes an image received by the user 13 from another user 13 such as a friend or a family member, an image downloaded by the user 13 on an Internet site, an image read by the user 13 with a scanner, and the like. The image 22 in the image folder 30 is periodically synchronized with the image 22 stored locally in the user terminal 11.

As shown in FIG. 4 as an example, the recommendation information DB 24 is divided into a product category 32 and a store category 33. The product category 32 stores the recommendation information 25 of product, and the store category 33 stores the store recommendation information 25. In the recommendation information 25 of product, an image of product, a name of product, a suggested retail price, a seller, a keyword related to the product, and the like are registered. In the store recommendation information 25, a store image, a store name, an address, a main product, a keyword related to the store, and the like are registered. In FIG. 4, a Japanese sake is illustrated as the product, and a soba restaurant is illustrated as the store.

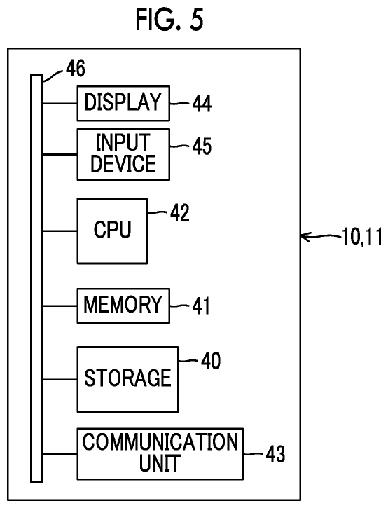

As shown in FIG. 5 as an example, the computers constituting the image management server 10 and the user terminal 11 have basically the same configuration and comprise a storage 40, a memory 41, a central processing unit (CPU) 42, a communication unit 43, a display 44, and an input device 45. The above parts are interconnected via a busline 46.

The storage 40 is a hard disk drive built into the computers constituting the image management server 10 and the user terminal 11, or connected through a cable or a network. Alternatively, the storage 40 is a disk array in which a plurality of hard disk drives are continuously mounted. The storage 40 stores a control program such as an operating system, various application programs (hereinafter abbreviated as AP), various pieces of data accompanying these programs, and the like. A solid state drive may be used instead of the hard disk drive.

The memory 41 is a work memory for the CPU 42 to execute the processing. The CPU 42 loads the program stored in the storage 40 into the memory 41 to execute the processing according to the program. Accordingly, the CPU 42 integrally controls each part of the computer. The CPU 42 is an example of a “processor” according to the technique of the present disclosure. The memory 41 may be built into the CPU 42.

The communication unit 43 is a network interface that controls transmission of various types of information via the network 12 or the like. The display 44 displays various screens. The various screens are provided with an operation function by a graphical user interface (GUI). The computers constituting the image management server 10 and the user terminal 11 receive an input of an operation instruction from the input device 45 through the various screens. The input device 45 is a keyboard, a mouse, a touch panel, and the like.

In the following description, a suffix “A” is assigned to each part of the computer constituting the image management server 10, and a suffix “B” is assigned to each part of the computer constituting the user terminal 11 as reference numerals to distinguish the computers.

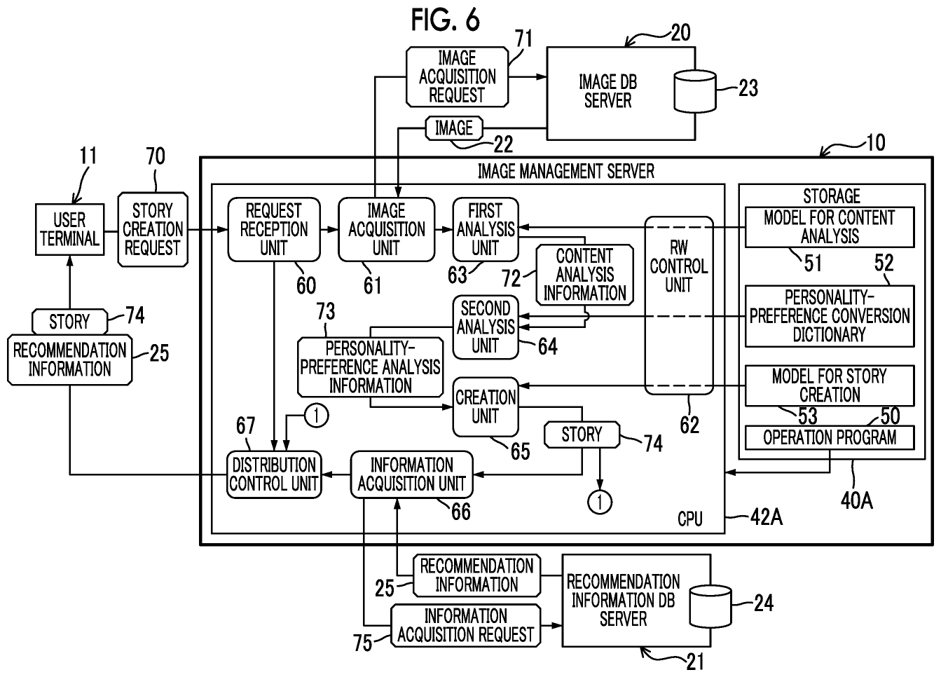

As shown in FIG. 6 as an example, an operation program 50 is stored in a storage 40A of the image management server 10. The operation program 50 is an AP for causing the computer constituting the image management server 10 to function as the “recommendation information presentation device” according to the technique of the present disclosure. That is, the operation program 50 is an example of an “operation program of recommendation information presentation device” according to the technique of the present disclosure. In addition to the operation program 50, the storage 40A stores a machine learning model for content analysis (hereinafter abbreviated as model for content analysis) 51, a personality-preference conversion dictionary 52, and a machine learning model for story creation (hereinafter model for story creation) 53.

In a case where the operation program 50 is started, the CPU 42A of the image management server 10 cooperates with the memory 41 and the like to function as a request reception unit 60, an image acquisition unit 61, a read/write (hereinafter abbreviated as RW) control unit 62, a first analysis unit 63, a second analysis unit 64, a creation unit 65, an information acquisition unit 66, and a distribution control unit 67.

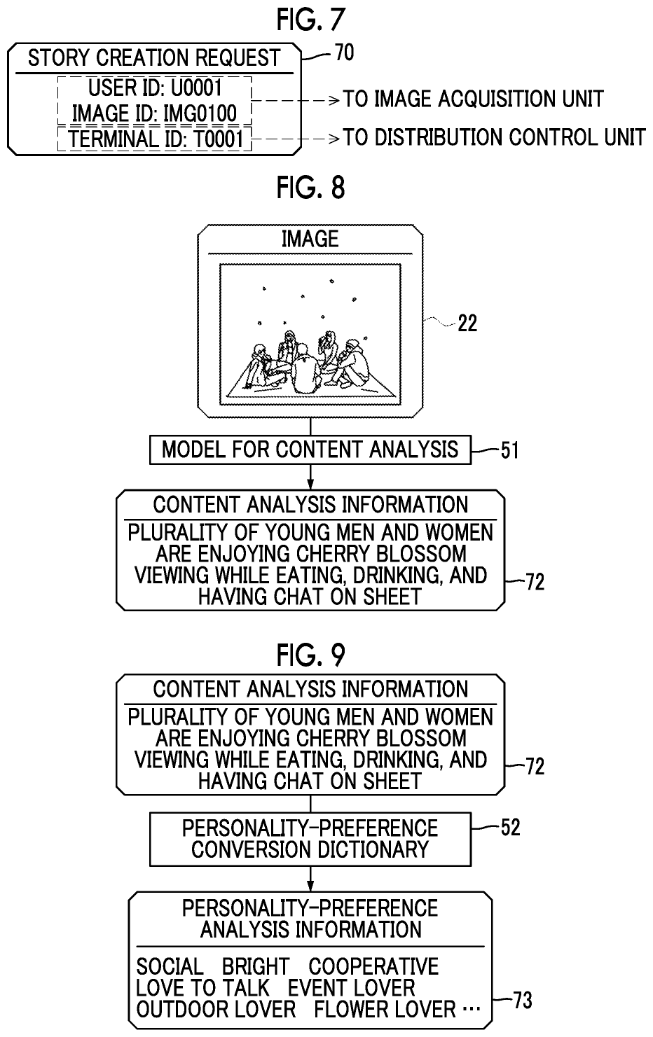

The request reception unit 60 receives various requests from the user terminal 11. For example, the request reception unit 60 receives a story creation request 70. The story creation request 70 requests the creation of a story 74 based on the image 22. As shown in FIG. 7 as an example, the story creation request 70 includes a user ID, an image ID, and a terminal ID. The image ID is an ID of the image 22 that requests the creation of the story 74. The terminal ID is an ID of the user terminal 11 that has transmitted the story creation request 70. The request reception unit 60 outputs the user ID and the image ID of the story creation request 70 to the image acquisition unit 61. Further, the request reception unit 60 outputs the terminal ID of the story creation request 70 to the distribution control unit 67.

In a case where the story creation request 70 is input from the request reception unit 60, the image acquisition unit 61 transmits image acquisition request 71 to the image DB server 20. The image acquisition request 71 is a copy of the user ID and the image ID of the story creation request 70, and is for requesting the acquisition of the image 22 designated by the image ID of the story creation request 70 in the image folder 30 designated by the user ID of the story creation request 70.

The image DB server 20 reads out, from the image DB 23, the image 22 in the image folder 30 in response to the image acquisition request 71, and transmits the readout image 22 to the image management server 10. The image acquisition unit 61 acquires the image 22 transmitted from the image DB server 20 in response to the image acquisition request 71. The image acquisition unit 61 outputs the acquired image 22 to the first analysis unit 63.

The RW control unit 62 controls the storage of various types of information in the storage 40A and the readout of various types of information in the storage 40A. For example, the RW control unit 62 reads out the model for content analysis 51 from the storage 40A and outputs the readout model for content analysis 51 to the first analysis unit 63. Further, the RW control unit 62 reads out the personality-preference conversion dictionary 52 from the storage 40A and outputs the readout personality-preference conversion dictionary 52 to the second analysis unit 64. Furthermore, the RW control unit 62 reads out the model for story creation 53 from the storage 40A and outputs the readout model for story creation 53 to the creation unit 65.

The first analysis unit 63 generates content analysis information 72 from the image 22 by using the model for content analysis 51. The content analysis information 72 is information obtained by analyzing the content of the image 22 (refer to also FIG. 8 and the like). The first analysis unit 63 outputs the content analysis information 72 to the second analysis unit 64.

The second analysis unit 64 generates personality-preference analysis information 73 from the content analysis information 72 by using the personality-preference conversion dictionary 52. The personality-preference analysis information 73 is information obtained by analyzing the personality preference of the user 13 (refer to also FIG. 9 and the like). The second analysis unit 64 outputs the personality-preference analysis information 73 to the creation unit 65. The personality-preference analysis information 73 is an example of “analysis information” according to the technique of the present disclosure.

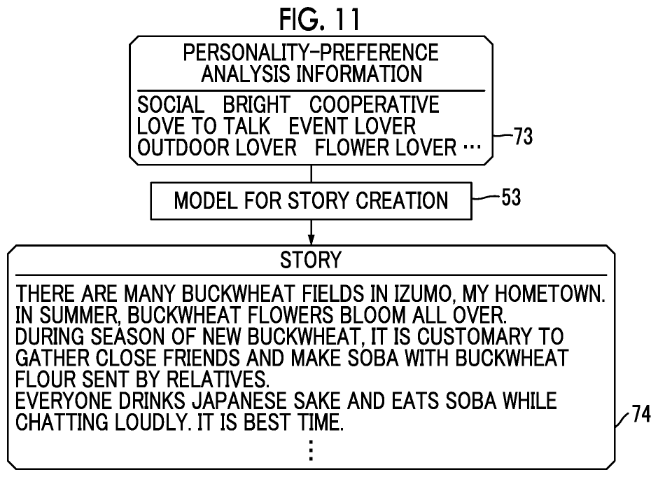

The creation unit 65 creates the story 74 by using the model for story creation 53. The story 74 is configured of a set of sentences describing a fictitious event based on the personality-preference analysis information 73 (refer to also FIG. 11 and the like). The story 74 is, for example, 200 characters or less. The creation unit 65 outputs the story 74 to the information acquisition unit 66 and the distribution control unit 67.

The information acquisition unit 66 transmits an information acquisition request 75 including a noun described in the story 74 as a search keyword to the recommendation information DB server 21. The recommendation information DB server 21 reads out, from the recommendation information DB 24, the recommendation information 25 having a keyword matching the search keyword of the information acquisition request 75, and transmits the readout recommendation information 25 to the image management server 10. The information acquisition unit 66 acquires the recommendation information 25 transmitted from the recommendation information DB server 21. In this manner, the information acquisition unit 66 selects the recommendation information 25 according to the story 74 from a plurality of pieces of recommendation information 25 registered in advance in the recommendation information DB 24. The information acquisition unit 66 outputs the acquired recommendation information 25 to the distribution control unit 67. The selection of the recommendation information 25 by the information acquisition unit 66 is an example of “generate recommendation information” and “generating recommendation information” according to the technique of the present disclosure.

The distribution control unit 67 performs control of distributing the story 74 from the creation unit 65 and the recommendation information 25 from the information acquisition unit 66 to the user terminal 11 that is a transmission source of the story creation request 70. In this case, the distribution control unit 67 specifies the user terminal 11, which is the transmission source of the story creation request 70, based on the terminal ID from the request reception unit 60. The distribution control unit 67 distributes the recommendation information 25 to the user terminal 11 to present the recommendation information 25 to the user 13.

As shown in FIG. 8 as an example, the first analysis unit 63 inputs the image 22 to the model for content analysis 51 and causes the content analysis information 72 to be output from the model for content analysis 51. The model for content analysis 51 is, for example, a combination of a convolutional neural network (CNN) that extracts a feature amount of the image 22 and a recurrent neural network (RNN) that extracts a feature amount of a sentence. The model for content analysis 51 outputs a caption representing the content of the input image 22 as the content analysis information 72. More specifically, the content analysis information 72 is a set of multidimensional feature amount vectors in which each part of speech constituting the caption is represented by a plurality of feature amounts. FIG. 8 shows an example of outputting, for the image 22 in which a state of cherry blossom viewing is captured, the content analysis information 72 having a content that “A plurality of young men and women are enjoying cherry blossom viewing while eating, drinking, and having a chat on a sheet”.

As shown in FIG. 9 as an example, the second analysis unit 64 applies the content analysis information 72 to the personality-preference conversion dictionary 52 to cause the personality-preference analysis information 73 to be output. A plurality of words representing the personality preference of the user 13 such as “social” and “outdoor lover” are registered in the personality-preference conversion dictionary 52. The second analysis unit 64 calculates a degree of similarity between the caption of the content analysis information 72 and the plurality of words of the personality-preference conversion dictionary 52. More specifically, the second analysis unit 64 calculates, as the degree of similarity, a Euclidean distance between the multidimensional feature amount vector representing the caption of the content analysis information 72 and the multidimensional feature amount vector representing the plurality of words of the personality-preference conversion dictionary 52. The second analysis unit 64 outputs a word whose calculated degree of similarity is within a threshold value range as the personality-preference analysis information 73. FIG. 9 shows an example of outputting, for the content analysis information 72 shown in FIG. 8, the personality-preference analysis information 73 such as “social”, “cooperative”, “event lover”, “outdoor lover”, and “flower lover”.

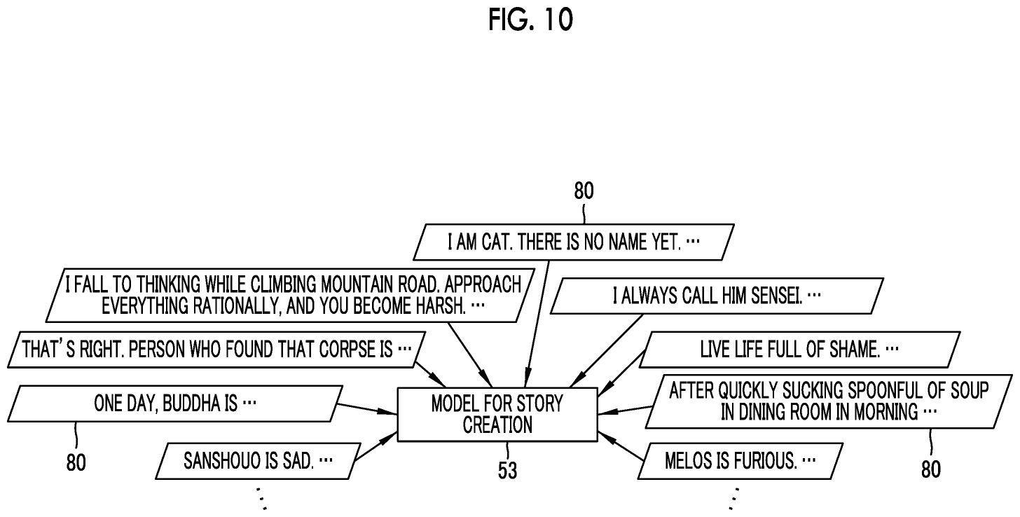

As shown in FIG. 10 as an example, a plurality of existing stories 80 are provided to the model for story creation 53. The existing story 80 is, for example, a passage of a novel whose copyright is expired (such as “I Am a Cat”, “Kusamakura”, “Shayo”, and “Sanshouo”). The model for story creation 53 performs, for example, morphological analysis, syntactic analysis, semantic analysis, and context analysis on the provided existing story 80. An essential structure of the existing story 80, such as expression tendency of words used in the existing story 80, is understood. The model for story creation 53 learns knowledge for creating the story 74 in such a manner that a baby gradually learns his/her native language. That is, the model for story creation 53 is generated by learning without teacher.

As shown in FIG. 11 as an example, the creation unit 65 inputs the personality-preference analysis information 73 into the model for story creation 53 and causes the story 74 to be output from the model for story creation 53. FIG. 11 shows an example of outputting, for the personality-preference analysis information 73 shown in FIG. 9, the story 74 having a content that “There are many buckwheat fields in Izumo, my hometown. . . . Everyone drinks Japanese sake and eats soba while chatting loudly. . . . ”.

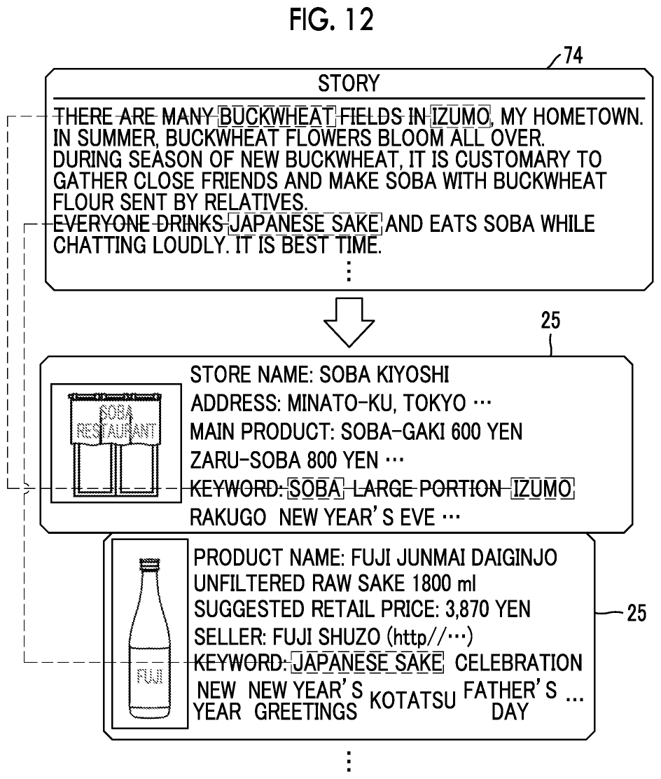

FIG. 12 shows an example of the recommendation information 25 according to the story 74 shown in FIG. 11. Specifically, as the recommendation information 25 of the store, a case is illustrated in which a soba restaurant having a store name “Soba Kiyoshi” is selected in which the words “Izumo” and “Soba” in the story 74 are registered as keywords. Further, as the recommendation information 25 of the product, a case is illustrated in which a product name “Fuji Junmai Daiginjo unfiltered raw sake 1800 ml” in which the word “Japanese sake” in the story 74 is registered as the keyword is selected.

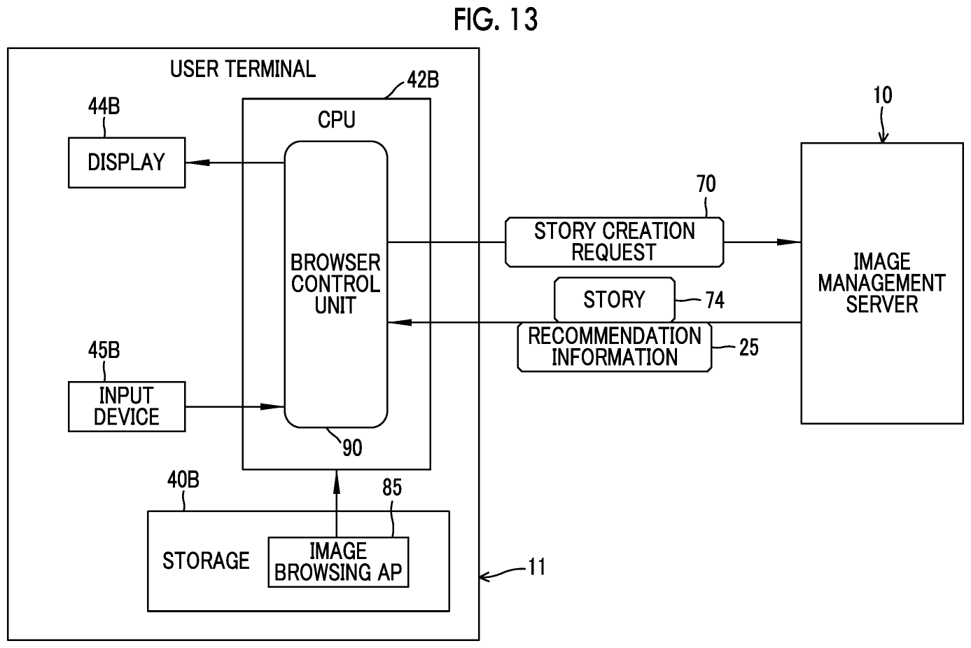

As shown in FIG. 13 as an example, a storage 40B of the user terminal 11 stores an image browsing AP 85. In a case where the image browsing AP 85 is executed and a web browser dedicated to the image browsing AP 85 is started, a CPU 42B of the user terminal 11 cooperates with the memory 41 and the like to function as a browser control unit 90. The browser control unit 90 controls the operation of the web browser.

The browser control unit 90 receives various operation instructions to be input from an input device 45B by the user 13 through the various screens. The operation instruction includes a story creation instruction to the image management server 10. The browser control unit 90 transmits a request in response to the operation instruction to the image management server 10. For example, the browser control unit 90 transmits the story creation request 70 to the image management server 10 in response to the story creation instruction.

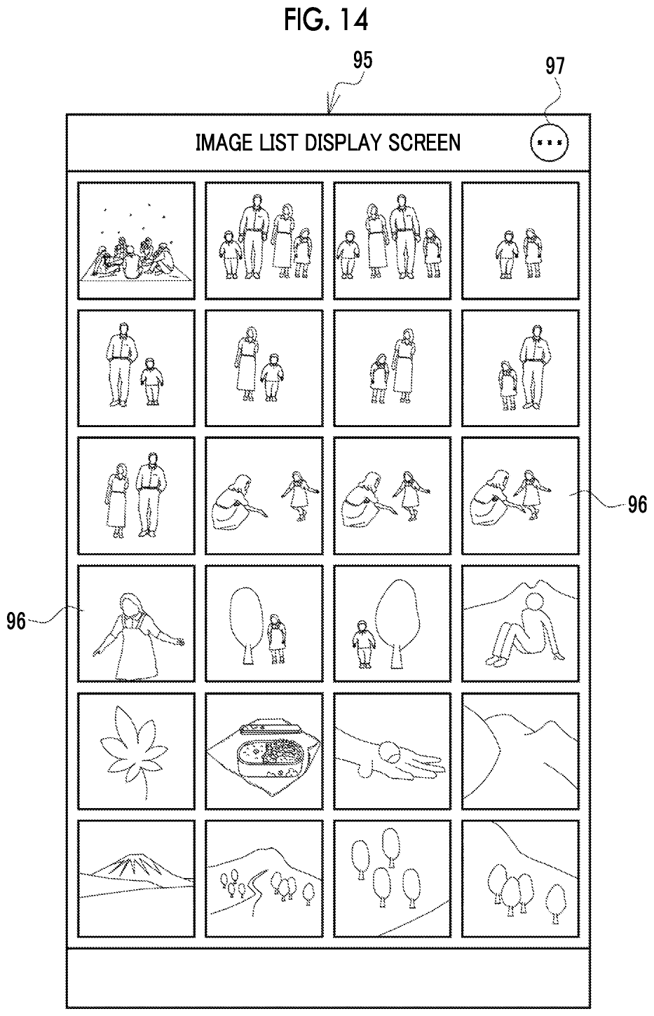

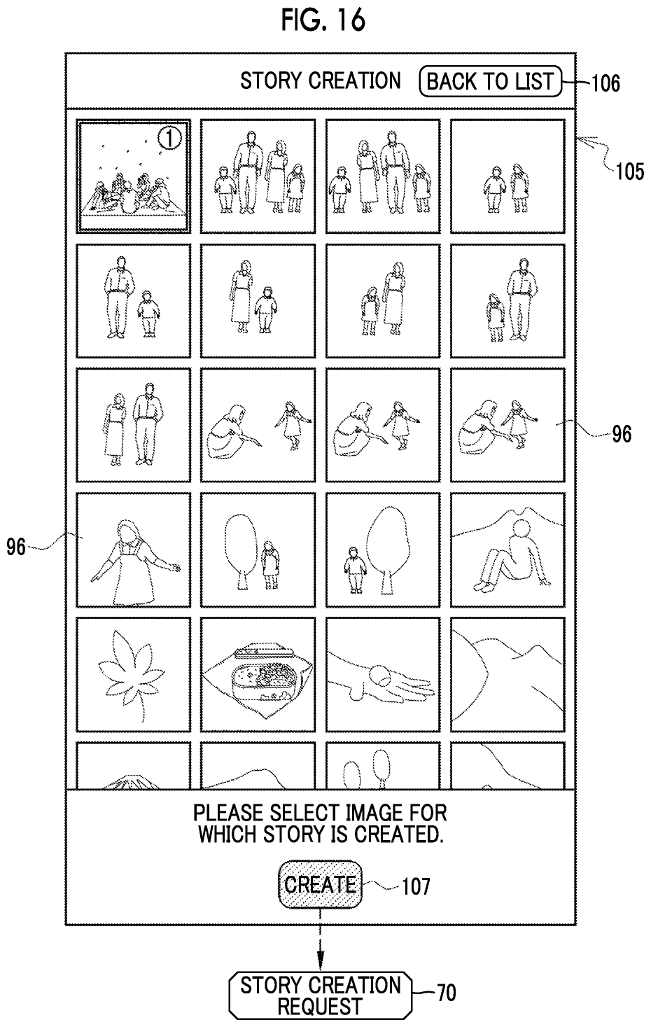

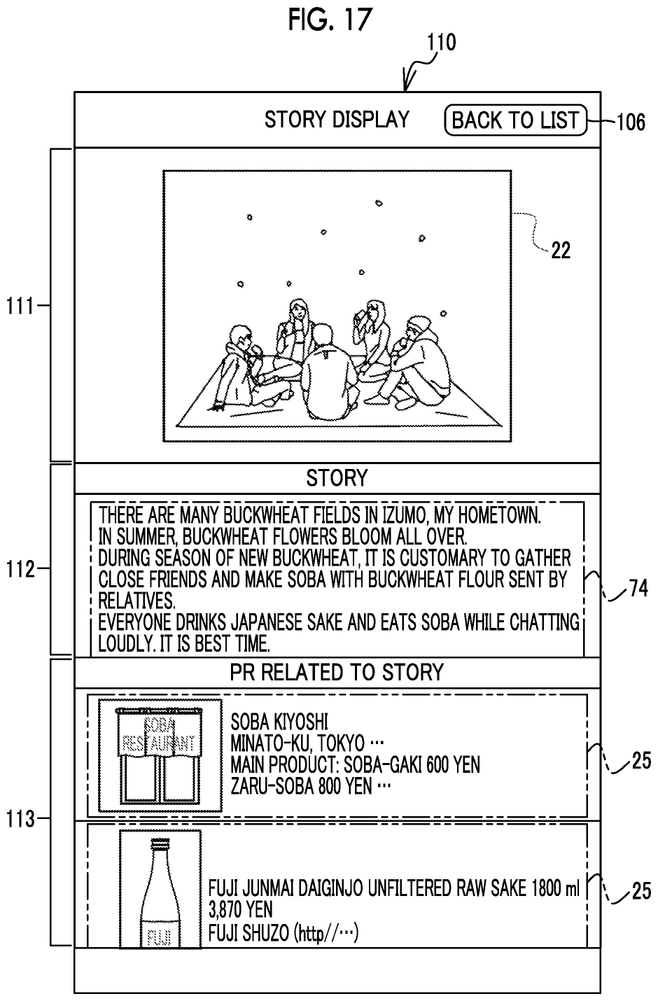

The browser control unit 90 generates various screens such as an image list display screen 95 that displays the images 22 as a list (refer to FIG. 14 and the like), a story creation instruction screen 105 that issues the story creation instruction (refer to FIG. 16), and a story display screen 110 that displays the story 74 (refer to FIG. 17), and displays the generated screens on a display 44B.

FIG. 14 shows an example of the image list display screen 95. On the image list display screen 95, thumbnail images 96 obtained by cutting out the image 22 into a square shape are arranged at equal intervals in vertical and horizontal directions. A menu display button 97 is provided on the upper part of the image list display screen 95.

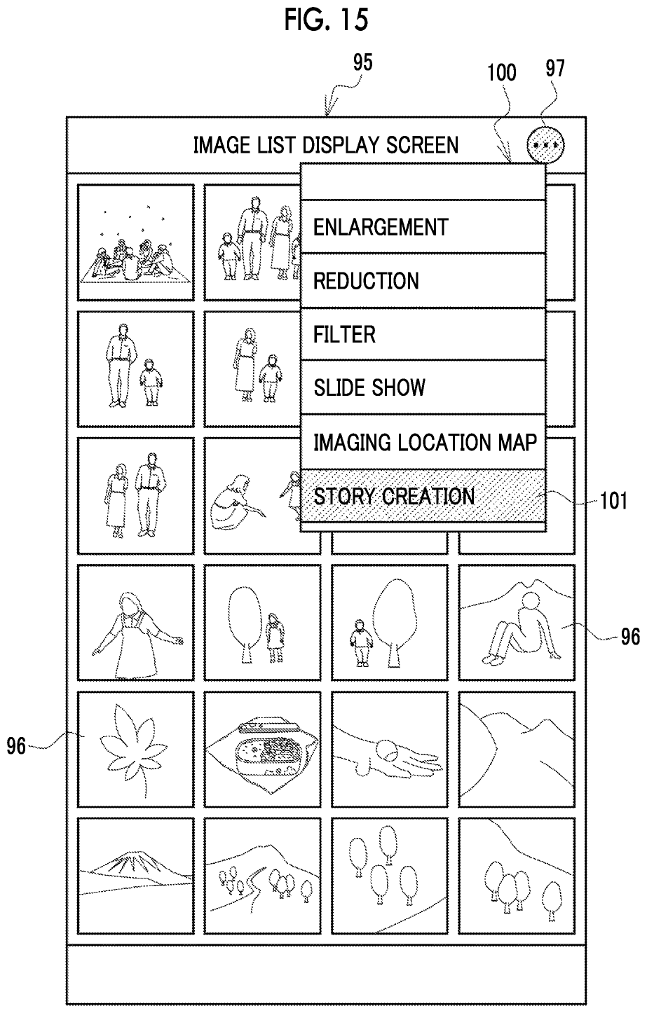

In a case where the menu display button 97 is selected, as shown in FIG. 15 as an example, the browser control unit 90 displays a context menu 100 on the image list display screen 95. The context menu 100 is provided with a menu bar 101 that issues an instruction to create the story 74, as well as menu bars that issue instructions to enlarge and reduce the image list and the like.

In a case where the menu bar 101 is selected, the browser control unit 90 shifts the display from the image list display screen 95 to the story creation instruction screen 105 shown in FIG. 16 as an example. The thumbnail image 96 is displayed in a selectable manner on the story creation instruction screen 105. A back button 106 is provided on the upper part of the story creation instruction screen 105. Further, a creation button 107 is provided on the lower part of the story creation instruction screen 105.

In a case where the back button 106 is selected, the browser control unit 90 returns the display from the story creation instruction screen 105 to the image list display screen 95. In a case where the thumbnail image 96 of the image 22 for which the story 74 is desired to be created is selected and then the creation button 107 is selected, the browser control unit 90 receives the story creation instruction and issues the story creation request 70.

The browser control unit 90 shifts the display from the story creation instruction screen 105 to the story display screen 110 shown in FIG. 17 as an example. The story display screen 110 includes an image display region 111, a story display region 112, and a recommendation information display region 113. In the image display region 111, the image 22 for which the thumbnail image 96 is selected on the story creation instruction screen 105, that is, the image 22 for which the story 74 is created is displayed. The story 74 is displayed in the story display region 112. The recommendation information 25 is displayed in the recommendation information display region 113. The recommendation information 25 can be selected. In a case where the recommendation information 25 is selected, the entire content of the recommendation information 25 is displayed in an enlarged manner. The back button 106 for returning to the image list display screen 95 is provided on the upper part of the story display screen 110, similarly to the story creation instruction screen 105.

FIG. 17 shows an example in which the image 22 of the cherry blossom viewing shown in FIG. 8 is displayed in the image display region 111, the story 74 shown in FIG. 11 or the like is displayed in the story display region 112, and the recommendation information 25 shown in FIG. 12 is displayed in the recommendation information display region 113.

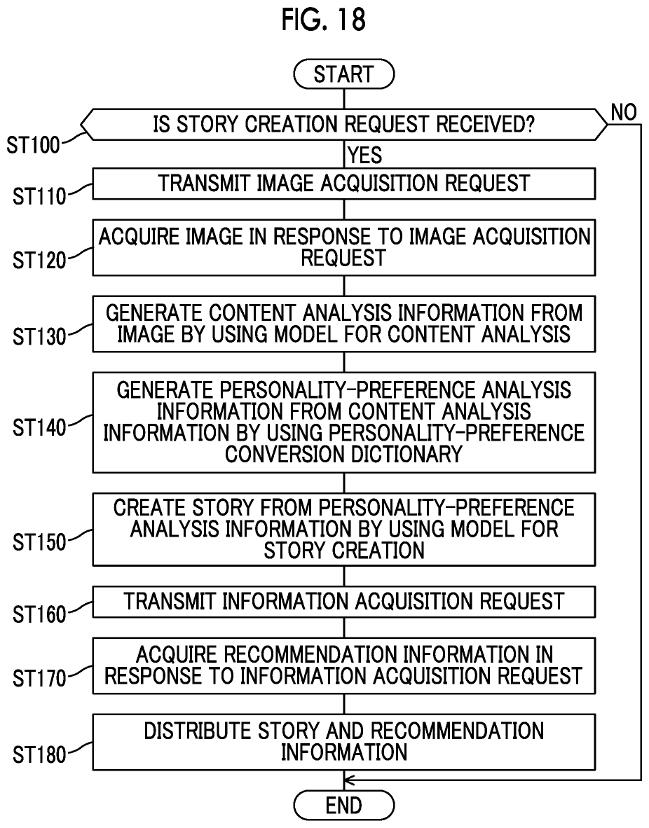

Next, an action of the above configuration will be described with reference to a flowchart shown in FIG. 18 as an example. In a case where the operation program 50 is started, the CPU 42A of the image management server 10 functions as the request reception unit 60, the image acquisition unit 61, the RW control unit 62, the first analysis unit 63, the second analysis unit 64, the creation unit 65, the information acquisition unit 66, and the distribution control unit 67, as shown in FIG. 6.

In a case where the image browsing AP 85 is started, the CPU 42B of the user terminal 11 functions as the browser control unit 90, as shown in FIG. 13.

As shown in FIG. 16, in a case where the thumbnail image 96 of the image 22 for which the story 74 is desired to be created is selected and the creation button 107 is selected on the story creation instruction screen 105, the story creation request 70 is issued from the browser control unit 90. The story creation request 70 is transmitted from the user terminal 11 to the image management server 10.

As shown in FIG. 18, in a case where the story creation request 70 from the user terminal 11 is received in the request reception unit 60 (YES in step ST100), the image acquisition request 71 is transmitted from the image acquisition unit 61 to the image DB server 20 (step ST110). The image 22 transmitted from the image DB server 20 in response to the image acquisition request 71 is acquired by the image acquisition unit 61 (step ST120). The image 22 is output from the image acquisition unit 61 to the first analysis unit 63.

As shown in FIG. 8, in the first analysis unit 63, the content analysis information 72 is generated from the image 22 by using the model for content analysis 51 (step ST130). The content analysis information 72 is output from the first analysis unit 63 to the second analysis unit 64.

As shown in FIG. 9, in the second analysis unit 64, the personality-preference analysis information 73 is generated from the content analysis information 72 by using the personality-preference conversion dictionary 52 (step ST140). The personality-preference analysis information 73 is output from the second analysis unit 64 to the creation unit 65.

As shown in FIG. 11, the creation unit 65 creates the story 74 from the personality-preference analysis information 73 by using the model for story creation 53 (step ST150). The story 74 is output from the creation unit 65 to the information acquisition unit 66 and the distribution control unit 67.

The information acquisition request 75 according to the story 74 is transmitted from the information acquisition unit 66 to the recommendation information DB server 21 (step ST160). The recommendation information 25 transmitted from the recommendation information DB server 21 in response to the information acquisition request 75 is acquired by the information acquisition unit 66 (step ST170). Accordingly, the recommendation information 25 according to the story 74 is selected. The recommendation information 25 is output from the information acquisition unit 66 to the distribution control unit 67.

Under the control of the distribution control unit 67, the story 74 and the recommendation information 25 are distributed to the user terminal 11, which is the transmission source of the story creation request 70 (step ST180).

In the user terminal 11, the distributed story 74 and recommendation information 25 are displayed as shown in FIG. 17 and provided for browsing by the user 13. The user 13 enjoys reading the story 74, making a plan to go to the store of the recommendation information 25, and considering purchase of the product of the recommendation information 25.

As described above, the CPU 42A of the image management server 10 comprises the second analysis unit 64, the creation unit 65, the information acquisition unit 66, and the distribution control unit 67. The second analysis unit 64 analyzes the image 22 to generate the personality-preference analysis information 73 obtained by analyzing a personality preference of the user 13 as the analysis information. The creation unit 65 inputs the personality-preference analysis information 73 into the model for story creation 53 and causes the story 74, which is configured of a set of sentences describing a fictitious event based on the personality-preference analysis information 73, to be output from the model for story creation 53. The information acquisition unit 66 selects the recommendation information 25 according to the story 74 from the plurality of pieces of recommendation information 25 registered in advance in the recommendation information DB 24 to generate the recommendation information 25 according to the story 74. The distribution control unit 67 distributes the recommendation information 25 to the user terminal 11 to present the recommendation information 25 to the user 13. Therefore, it is possible to present the recommendation information 25, which is filled with unexpectedness, to the user 13. It is suitable for the user 13 who is accustomed to daily life and seeks a stimulus.

In a method of totaling product popularity and recommending a product based on the popularity, it is necessary to total the popularity. Further, in a method of storing a product purchase history of the user 13 and recommending the product based on the purchase history, it is necessary to store the purchase history. On the contrary, in the technique of the present disclosure, it is not necessary to total the popularity and store the purchase history.

The second analysis unit 64 generates the personality-preference analysis information 73 obtained by analyzing the personality preference of the user 13 as “analysis information” according to the technique of the present disclosure. Therefore, it is possible to create the story 74 that is not so much affected by the content of the image 22. As a result, it is possible to present the more unexpected recommendation information 25 to the user 13. Further, it is possible to present, to the user 13, the recommendation information 25 that matches the personality preference of the user 13.

The first analysis unit 63 generates content analysis information 72 from the image 22 by using the model for content analysis 51. Therefore, it is possible to easily generate the content analysis information 72.

The second analysis unit 64 generates personality-preference analysis information 73 from the content analysis information 72 by using the personality-preference conversion dictionary 52. Therefore, it is possible to easily generate the personality-preference analysis information 73.

The information acquisition unit 66 selects the recommendation information 25 according to the story 74 from the plurality of pieces of recommendation information 25 registered in advance in the recommendation information DB 24. Therefore, it is possible to easily generate the recommendation information 25.

In addition to the use of the model for content analysis 51, tag information attached to the image 22 may be referred to generate the content analysis information 72. Similarly, in addition to the use of the personality-preference conversion dictionary 52, the tag information may be referred to generate the personality-preference analysis information 73.

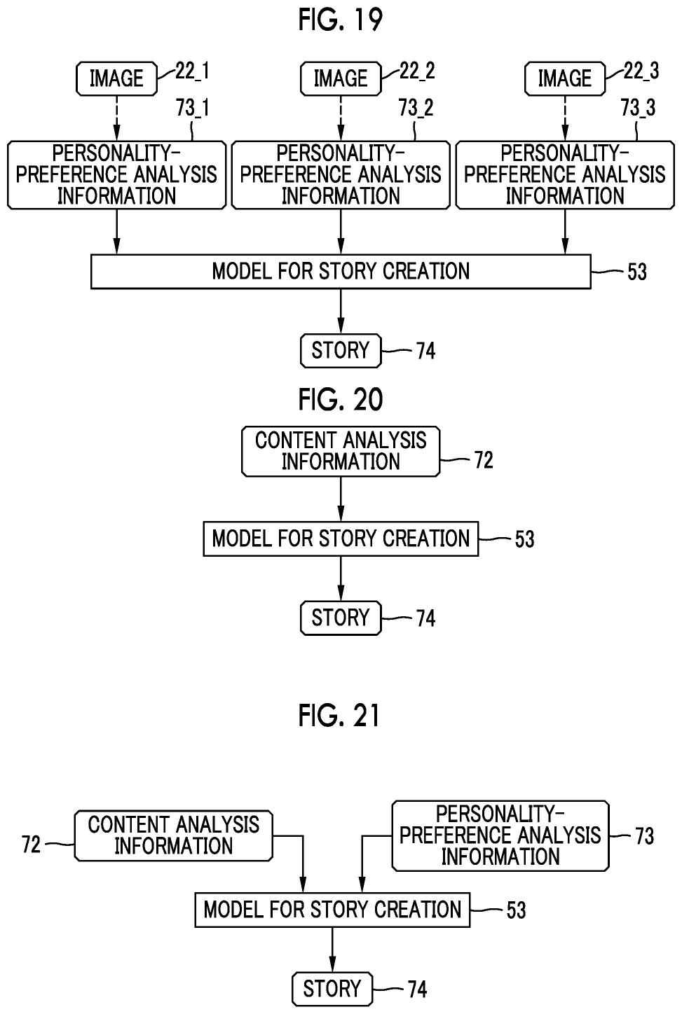

In the above example, one piece of personality-preference analysis information 73 generated from one image 22 is input to the model for story creation 53, but the present disclosure is not limited thereto. A plurality of images 22 may be used, or a plurality of pieces of personality-preference analysis information 73 to be input to the model for story creation 53 also may be used. As an example, as shown in FIG. 19, three pieces of personality-preference analysis information 73_1, 73_2, and 73_3 generated from three images 22_1, 22_2, and 22_3 may be input to the model for story creation 53. In this manner, it is possible to create the story 74 that incorporates various personality preferences of the user 13. As a result, it is possible to present, to the user 13, the recommendation information 25 that comprehensively reflects the personality preference of the user 13.

Further, as shown in FIG. 20 as an example, the content analysis information 72 may be input to the model for story creation 53 instead of the personality-preference analysis information 73. In this case, the content analysis information 72 is an example of “analysis information” according to the technique of the present disclosure. As described above, in a case where the content analysis information 72 is the “analysis information” according to the technique of the present disclosure, it is possible to create the story 74 somewhat following the content of the image 22, as compared with a case where the personality-preference analysis information 73 is the “analysis information” according to the technique of the present disclosure. As a result, it is possible to present the recommendation information 25 that matches the content of the image 22 to the user 13, while having unexpectedness.

Further, as shown in FIG. 21 as an example, both the content analysis information 72 and the personality-preference analysis information 73 may be input to the model for story creation 53. In this manner, it is possible to create the story 74 in which the content of the image 22 and the personality preference of the user 13 are interwoven in a well-balanced manner. As a result, it is possible to present, to the user 13, the recommendation information 25 that is suitable for the content of the image 22 and the personality preference of the user 13 in a well-balanced manner.

Although not illustrated, a plurality of pieces of content analysis information 72 generated from the plurality of images 22 or a plurality of sets of the content analysis information 72 and the personality-preference analysis information 73 generated from the plurality of images 22 may be input to the model for story creation 53, similarly to the example shown in FIG. 19.

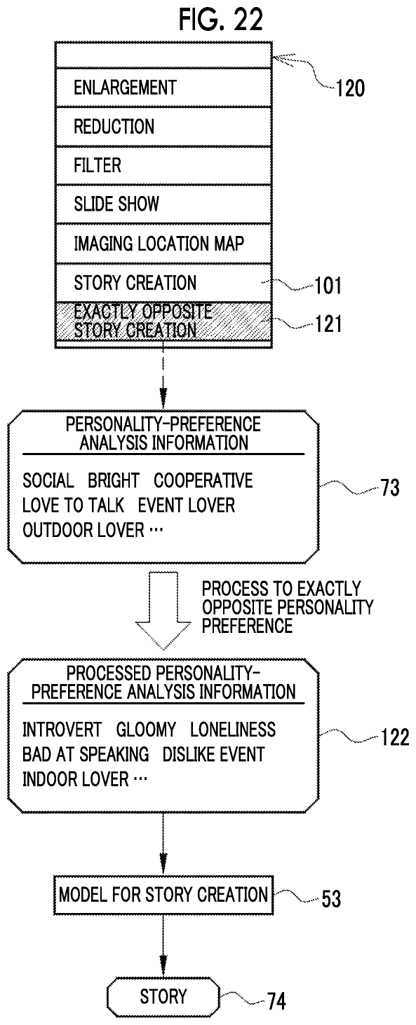

An aspect shown in FIG. 22 may be applied. As shown in FIG. 22 as an example, in the present aspect, a menu bar 121 that issues an instruction to create a story exactly opposite to the story 74 is provided in a context menu 120 displayed in a case where the menu display button 97 is selected, in addition to the menu bar 101 that issues the instruction to create the story 74.

In a case where the menu bar 121 is selected, the second analysis unit 64 processes the personality-preference analysis information 73 to generate processed personality-preference analysis information 122 that represents a personality preference different from the personality preference of the user 13. The processed personality-preference analysis information 122 is obtained by replacing a word representing the personality preference of the user 13 included in the personality-preference analysis information 73 with a word exactly opposite to the word. For example, “social” in the personality-preference analysis information 73 is replaced with “introverted”, which is an opposite term. Further, “outdoor lover” in the personality-preference analysis information 73 is replaced with “indoor lover”, which is an opposite term. Specifically, the above replacement processing is to set a direction of the multidimensional feature amount vector representing the word of the personality-preference analysis information 73 to an opposite direction.

The creation unit 65 inputs the processed personality-preference analysis information 122 into the model for story creation 53 and causes the story 74 to be output from the model for story creation 53. In this case, the processed personality-preference analysis information 122 is an example of “analysis information” according to the technique of the present disclosure.

As described above, in the aspect shown in FIG. 22, the processed personality-preference analysis information 122, which is obtained by processing the personality-preference analysis information 73 and represents the personality preference different from the personality preference of the user 13, is generated as “analysis information” according to the technique of the present disclosure. Therefore, it is possible to create the story 74 that is different from the personality preference of the user 13. As a result, it is possible to present the furthermore unexpected recommendation information 25 to the user 13.

A degree to which the word representing the personality preference of the user 13 included in the personality-preference analysis information 73 is replaced may be configured to be settable. For example, a setting in which all the words included in the personality-preference analysis information 73 are replaced with opposite terms, a setting in which about 70% of the words included in the personality-preference analysis information 73 are replaced with opposite terms, a setting in which half of the words included in the personality-preference analysis information 73 are replaced with opposite terms, and a setting in which about 30% of the words included in the personality-preference analysis information 73 are replaced with opposite terms may be configured to be selectable.

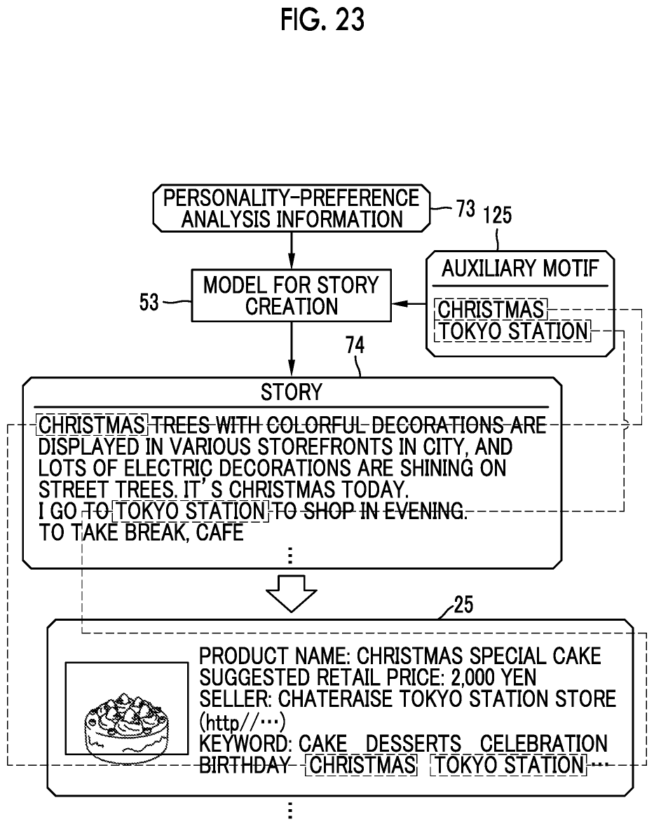

Further, an aspect shown in FIG. 23 may be applied. As shown in FIG. 23 as an example, in the present aspect, an auxiliary motif 125 is input to the model for story creation 53 in addition to the personality-preference analysis information 73. The model for story creation 53 creates the story 74 based on the personality-preference analysis information 73 and the auxiliary motif 125.

The auxiliary motif 125 is a word that assists in creating the story 74. The auxiliary motif 125 is a word input by the user 13 on the story creation instruction screen 105. Alternatively, the auxiliary motif 125 is prepared by the creation unit 65 selecting an appropriate word from the dictionary stored in the storage 40A. An example of the word selected by the creation unit 65 includes so-called a seasonal word related to the current date. In a case where the current date is December, the seasonal word is, for example, “Shiwasu (nickname for December in Japan)”, “Year-end”, “Christmas”, and “Red and White Song Battle (famous TV concert at the end of the year in Japan)”. Further, an example of the word selected by the creation unit 65 includes a word representing a place. The word representing the place is, for example, “Hokkaido”, “Sendai”, “Tokyo Station”, “Sky Tree”, “Mt. Tsukuba”, “Kuala Lumpur”, and “Los Angeles”.

FIG. 23 illustrates a case where “Christmas” and “Tokyo Station” are used as the auxiliary motif 125. An example is shown in which the story 74 having a content that “Christmas trees with colorful decorations are displayed in various storefronts in city, . . . I go to Tokyo Station to shop in the evening. . . . ” is output. Further, a case is illustrated in which a product name “Christmas Special Cake” of a seller “Chateraise Tokyo Station Store”, in which the words “Christmas” and “Tokyo Station” in the story 74 are registered as keywords, is selected as the recommendation information 25 of product.

As described above, in the aspect shown in FIG. 23, the auxiliary motif 125 that assists in creating the story is input to the model for story creation 53, in addition to the personality-preference analysis information 73. Therefore, it is possible to control the content of the story 74 to some extent by the auxiliary motif 125. Therefore, it is possible to prevent the story 74 that is too irrelevant from being created and the recommendation information 25 that is completely unfamiliar from being presented to the user 13.

The content analysis information 72 is generated from the image 22 by using the model for content analysis 51, and the personality-preference analysis information 73 is generated from the content analysis information 72 by using the personality-preference conversion dictionary 52. However, the present disclosure is not limited thereto. A machine learning model that directly generates the personality-preference analysis information 73 from the image 22 may be used.

The recommendation information 25 according to the story 74 is selected from the plurality of pieces of recommendation information 25 registered in the recommendation information DB 24 to generate the recommendation information 25. However, the present disclosure is not limited thereto. The recommendation information 25 according to the story 74 may be generated by using the machine learning model in which the story 74 is used as input data and the recommendation information 25 is used as output data.

Although the recommendation information 25 is displayed on the story display screen 110, the present disclosure is not limited thereto. Only the image 22 and the story 74 may be displayed on the story display screen 110, and the recommendation information 25 may be displayed on a separate screen in a case where an instruction is issued by the user 13.

Although the image 22 for creating the story 74 is selected by the user 13, the present disclosure is not limited thereto. The image 22 for creating the story 74 may be randomly acquired by the image acquisition unit 61. Alternatively, the image acquisition unit 61 may acquire the image 22 that satisfies a condition set in advance, such as a predetermined number of images 22 captured most recently.

A plurality of models for story creation 53 for creating a plurality of stories 74 having different tones may be prepared, and the user 13 may select which of these models for story creation 53 is used to create the story 74. Examples of the plurality of models for story creation 53 for creating the plurality of stories 74 having different tones include a model for creating the story 74 in a literary style in the Meiji era, a model for creating the story 74 in a mystery style, and a model for creating the story 74 in a newspaper style. A model for creating the story 74 in a specific writer style may be employed.

Various screens such as the story display screen 110 may be generated in the image management server 10 and distributed to the user terminal 11 in a format of screen data for web distribution created by a markup language such as an extensible markup language (XML). In this case, the browser control unit 90 reproduces the various screens displayed on the web browser based on the screen data and displays the screens on the display 44B. Instead of XML, another data description language such as JavaScript (registered trademark) object notation (JSON) may be used.

The user terminal 11 that transmits the image 22 to the image management server 10 and the user terminal 11 that receives the distribution of the recommendation information 25 may be separate from each other. For example, in a case where there are a plurality of user terminals 11 having the same account of the user 13, one of the user terminals 11 may transmit the image 22 to the image management server 10 and the recommendation information 25 may be distributed from the image management server 10 to another user terminal.

A form of presenting the recommendation information 25 to the user 13 is not limited to the form of distributing the recommendation information 25 to the user terminal 11. The recommendation information 25 may be printed on a paper medium and the paper medium may be mailed to the user 13, or the recommendation information 25 may be attached to an e-mail to be transmitted.

Various modifications can be made for a hardware configuration of the computer constituting the image management server 10. For example, the image management server 10 may be configured of a plurality of computers separated as hardware for a purpose of improving processing capability and reliability. For example, the functions of the request reception unit 60, the image acquisition unit 61, the information acquisition unit 66, and the distribution control unit 67, and the functions of the RW control unit 62, the first analysis unit 63, the second analysis unit 64, and the creation unit 65 are carried by two computers in a distributed manner. In this case, the image management server 10 is configured with two computers. Further, the image management server 10, the image DB server 20, and the recommendation information DB server 21 may be integrated into one server.

As described above, the hardware configuration of the computer of the image management servers 10 may be changed as appropriate according to required performance such as processing capability, safety, and reliability. Further, not only the hardware but also the AP such as the operation program 50, for the purpose of ensuring safety and reliability, may be duplicated or stored in a plurality of storage devices in a distributed manner.

The user terminal 11 may be responsible for a part or all of the functions of each processing unit of the image management server 10.

In the above embodiments, for example, the following various processors can be used as a hardware structure of the processing units that execute various pieces of processing, such as the request reception unit 60, the image acquisition unit 61, the RW control unit 62, the first analysis unit 63, the second analysis unit 64, the creation unit 65, the information acquisition unit 66, the distribution control unit 67, and the browser control unit 90. The various processors include a programmable logic device (PLD) which is a processor whose circuit configuration is changeable after manufacturing such as a field programmable gate array (FPGA) and/or a dedicated electric circuit which is a processor having a circuit configuration exclusively designed to execute specific processing such as an application specific integrated circuit (ASIC), and the like, in addition to the CPUs 42A and 42B which are general-purpose processors that execute software (operation program 50 and image browsing AP 85) to function as the various processing units.

One processing unit may be configured by one of the various types of processors or may be configured by a combination of two or more processors of the same type or different types (for example, a combination of a plurality of FPGAs and/or a combination of a CPU and an FPGA). The plurality of processing units may be configured of one processor.

As an example of configuring the plurality of processing units with one processor, first, there is a form in which one processor is configured by a combination of one or more CPUs and software and the processor functions as the plurality of processing units, as represented by computers such as a client and a server. Second, there is a form in which a processor that realizes the functions of the entire system including the plurality of processing units with one integrated circuit (IC) chip is used, as represented by a system-on-chip (SoC) or the like. As described above, the various processing units are configured using one or more of the various processors as the hardware structure.

More specifically, a circuitry combining circuit elements such as semiconductor elements may be used as the hardware structure of the various processors.

The above various embodiments and/or various modification examples can be combined as appropriate in the technique of the present disclosure. It is needless to say that the technique of the present disclosure is not limited to the above embodiments and various configurations can be employed without departing from the gist. Further, the technique of the present disclosure extends to a storage medium that stores the program non-transitorily, in addition to the program.

The description content and the illustrated content described above are detailed descriptions of portions according to the technique of the present disclosure and are merely an example of the technique of the present disclosure. For example, the above description of the configurations, functions, actions, and effects is an example of the configurations, functions, actions, and effects of the portions according to the technique of the present disclosure. Therefore, it is needless to say that an unnecessary part may be deleted, a new element may be added, or a replacement may be performed to the description content and the illustrated content described above within a scope not departing from the gist of the technique of the present disclosure. In order to avoid complication and facilitate understanding of the portion according to the technique of the present disclosure, the description related to common general knowledge not requiring special description in order to implement the technique of the present disclosure is omitted in the above description content and illustrated content.

In the present specification, “A and/or B” is synonymous with “at least one of A or B”. That is, “A and/or B” means that only A may be used, only B may be used, or a combination of A and B may be used. In the present specification, the same concept as “A and/or B” is also applied to a case where three or more matters are linked and expressed by “and/or”.

All documents, patent applications, and technical standards described in this specification are incorporated by reference in this specification to the same extent as in a case where the incorporation of each individual document, patent application, and technical standard by reference is specifically and individually described.

What is claimed is:

1. A recommendation information presentation device comprising:
a processor; and
a memory connected to or built into the processor,
wherein the processor
analyzes an image held by a user to generate analysis information,
inputs the analysis information to a machine learning model for story creation and causes a story configured of a set of sentences describing a fictitious event based on the analysis information to be output from the machine learning model for story creation,
generates recommendation information according to the story, and
presents the recommendation information to the user.

2. The recommendation information presentation device according to claim 1,
wherein the processor generates, as the analysis information,
at least one of content analysis information obtained by analyzing a content of the image,
personality-preference analysis information obtained by analyzing a personality preference of the user, or
processed personality-preference analysis information that is information obtained by processing the personality-preference analysis information and represents a personality preference different from the personality preference of the user.

3. The recommendation information presentation device according to claim 2,
wherein the processor generates the content analysis information from the image by using a machine learning model for content analysis.

4. The recommendation information presentation device according to claim 2,
wherein the processor generates the personality-preference analysis information from the content analysis information by using a personality-preference conversion dictionary.

5. The recommendation information presentation device according to claim 1,
wherein the processor selects the recommendation information according to the story from a plurality of pieces of the recommendation information registered in advance.

6. The recommendation information presentation device according to claim 1,
wherein the processor inputs an auxiliary motif that assists in creating the story to the machine learning model for story creation, in addition to the analysis information.

7. An operation method of a recommendation information presentation device comprising:
analyzing an image held by a user to generate analysis information;
inputting the analysis information to a machine learning model for story creation and causing a story configured of a set of sentences describing a fictitious event based on the analysis information to be output from the machine learning model for story creation;
generating recommendation information according to the story; and
presenting the recommendation information to the user.

8. A non-transitory computer-readable storage medium storing an operation program of a recommendation information presentation device that causes a computer to execute a process comprising:
analyzing an image held by a user to generate analysis information;
inputting the analysis information to a machine learning model for story creation and causing a story configured of a set of sentences describing a fictitious event based on the analysis information to be output from the machine learning model for story creation;
generating recommendation information according to the story; and
presenting the recommendation information to the user.
